(19) United States
(12) Patent Application Publication
(10) Pub. No.: US 2026/0274415 A1
(43) Pub. Date: Sep. 17, 2026

(54) AERONAUTICAL CONVEYING AND DROPPING DEVICE

(71) Applicant: ARESIA-Valenton, Valenton (FR)

(72) Inventors: Valentin LEBRU, Valenton (FR); Frédéric GANDON, Valenton (FR)

(73) Assignee: ARESIA-Valenton, Valenton (FR)

(21) Appl. No.: 19/163,282

(22) PCT Filed: Mar. 8, 2024
(86) PCT No.: PCT/FR2024/050289

§ 371 Date: Sep. 8, 2025

(30) Foreign Application Priority Data
Mar. 9, 2023 (FR) FR2302202

(51) Int. Cl. B64D 1/12; B64D 1/04

(52) U.S. Cl. CPC B64D 1/12; B64D 1/04

(57) ABSTRACT

An aeronautical conveying and dropping device for a missile to be released, comprising at least a frame, a hook capable of retaining the missile to be released, a deformable parallelogram mechanism having an axis secured to the frame, two axes secured to the hook and a free axis arranged in the frame, a first cam mounted so as to rotate about an axis fixed in the frame and having a position for locking the deformable parallelogram mechanism by contact with a bearing mounted on the free axis of the deformable parallelogram mechanism, and an unlocking position, and a member for preloading the first cam in the locking position.

The invention relates to the field of aeronautical conveying and dropping devices, in particular release units. Release units are conveying and dropping devices for aircraft that can alternately hold and release on command an aeronautical vehicle, also known as a load. Release units are intended to be mounted on fixed or rotating wing aircraft, typically armed aircraft, helicopters, drones or other flying craft.

A release unit is typically installed in the lower part of an aircraft, for example under a fuselage or under a wing. The release unit receives an aeronautical vehicle, that it holds during flight. Upon receipt of a separation command, the release unit releases the aeronautical vehicle, which moves away from the aircraft, generally by gravity.

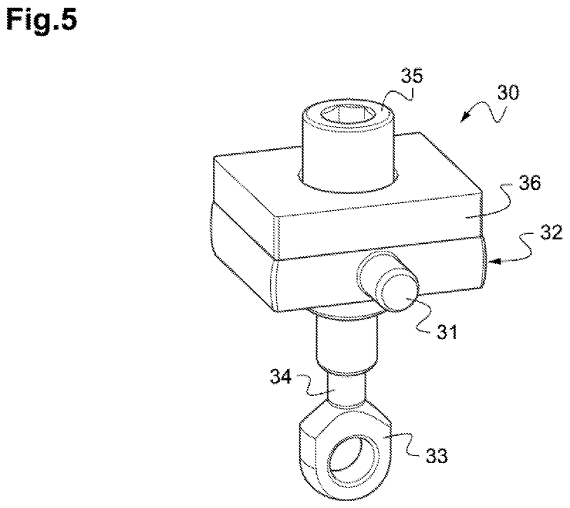

U.S. Pat. No. 3,093,031 shows a release mechanism with a chassis, tandem-arranged hooks rotating about pivots, fingers, a pin, an arm, a trigger, and a spring. The deformable parallelogram of FIG. 5 comprises two pivots fixed on the chassis, two hooks, and two fingers secured to the hooks, one per hook. The pin is outside of the deformable parallelogram. The arm is not in contact with a bearing of the deformable parallelogram, even less on a free axis of the deformable parallelogram.

EP144265 describes a device for carrying and dropping loads with triple escapement rockers. A deformable parallelogram is formed by the free axis articulating the connecting rods 26, 27 and 28 while the axis between the connecting rods 28 and 29 is outside of the deformable parallelogram. Neither the axis connecting the connecting rods 26, 27 and 28, nor the axis between the connecting rods 28 and 29 supports a bearing. The axis articulating the connecting rods 26, 27 and 28 is not free. The cam 32 is distant from the two aforementioned axis.

However, known release units are heavy and complex. Safety procedures, training, maintenance time, recharging time and safety are sources of costs, human errors and risks for the mission of the aircraft and, in some cases, the maintenance operators.

Furthermore, the operation of the known ejectors necessarily includes a manual safety procedure using a safety pin, handled by an operator at the end of the runway. The safety pin is removed immediately before take-off, and returned at the end of the mission if the aeronautical vehicle has not been released. The operator is subjected to bad weather and runway risks. The pin may be lost on the runway, endangering other aircraft. Furthermore, forgetting to remove the pin before take-off compromises the mission. The human factor is crucial. There is a need relating to on-board safety on the ejectors, independent of the human factor and not endangering other aircraft and the successful accomplishment of missions.

Improving the precision of the aeronautical vehicles results in a reduction in the weight thereof. The need has emerged for lightweight release units for aeronautical vehicles weighing less than 120 kg, or even less than or equal to 50 kg.

The invention improves the situation.

The aim of the invention is to reduce the weight of the release unit for increased performance.

The invention proposes an aeronautical conveying and dropping device for an aeronautical vehicle to be released, comprising at least one frame, one hook capable of holding the aeronautical vehicle to be released, one deformable parallelogram mechanism having an axis secured to the frame, two axis secured to the hook and one free axis, arranged in the frame, one first cam mounted so as to rotate about an axis fixed in the frame and having a position for locking the deformable parallelogram mechanism by contact with a bearing mounted on the free axis of the deformable parallelogram mechanism, and an unlocking position, and a member for preloading the first cam in the locking position. Thanks to the invention, the release unit has a simple and lightweight structure.

In one embodiment, the device comprises an electric actuator for releasing the aeronautical vehicle, for moving the first cam in the unlocking direction, the electric actuator having an idle position and an active position.

In one embodiment, the device comprises a second cam coupled to the first cam and an electric actuator for releasing the aeronautical vehicle, actuating the second cam in the unlocking direction, the electric actuator comprising at least one rotary motor having an idle position and an active position and a connecting rod. Redundancy is ensured. Each motor is sufficient for actuating the second cam.

In one embodiment, the connecting rod couples two rotary motors, the two rotary motors having an idle position and an active position, the connecting rod pushing the second cam. The mechanism is compact. The motors have a diameter larger than the height thereof.

In one embodiment, the connecting rod comprises a pin in contact with the second cam, the pin being arranged between the rotary motors. The axis of the motors and of the cams are arranged according to an isosceles triangle.

In one embodiment, the rotary motor has an axis parallel to the axis of rotation of the first and second cams. The forces are low.

In one embodiment, the first and second cams are one-piece. The mechanism is compact and lightweight.

In one embodiment, the device comprises a preloading member acting on the first and second cams by exerting a force towards the locking position. The locked position is stable.

In one embodiment, the first cam has an active surface for blocking the parallelogram mechanism, said surface being rounded convex. The blocking is stable.

In one embodiment, the first cam has a concave active surface in contact with the bearing in the unlocked position to provide a stable unlocking position. The mechanism can leave the unlocked position with a selected force.

In one embodiment, the device comprises a mechanical actuator acting on the hook for adjusting the locked position, the mechanical actuator being pivotably mounted about an axis of the frame and connected to one of said two axis secured to the hook. The preloading is adjustable. Torsion generation is prevented.

In one embodiment, the mechanical actuator acts directly on the hook, the mechanical actuator comprising a screw engaged in a nut, the nut being pivotably mounted relative to the frame and the screw being pivotably mounted relative to the hook. The preloading exerted by the hook on the load may be adjusted by means of a torque wrench.

In one embodiment, the deformable parallelogram mechanism has two axis secured to the frame, one of which is secured to the hook. The device has a reduced weight.

In one embodiment, the preloading member comprises a spring connected to a finger secured to the first cam. The spring may be attached to the frame near said axis secured to the frame.

In one embodiment, the preloading member comprises a magnet forming part of the rotary motor(s). The device is compact and highly reliable.

In one embodiment, the device comprises a controlled linear actuator mounted between an arm secured to the first cam and a member secured to the frame. The device is of simple and robust construction.

Other features and advantages of the invention will appear upon examining the detailed description below, and the attached drawings, wherein:

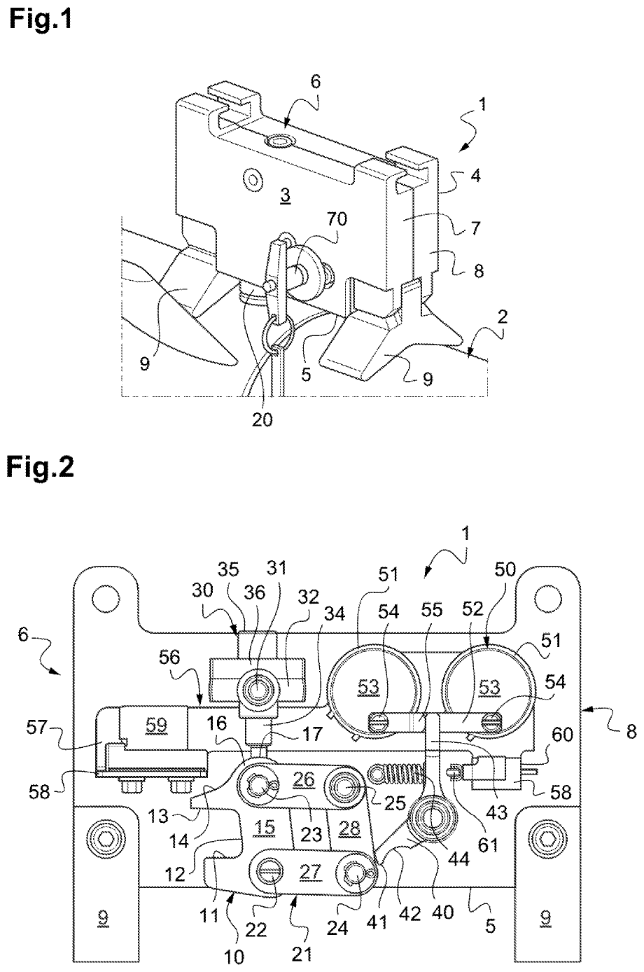

FIG. 1 schematically illustrates in perspective a device according to one aspect of the invention carrying a load.

FIG. 2 schematically illustrates in elevation a device according to one aspect of the invention.

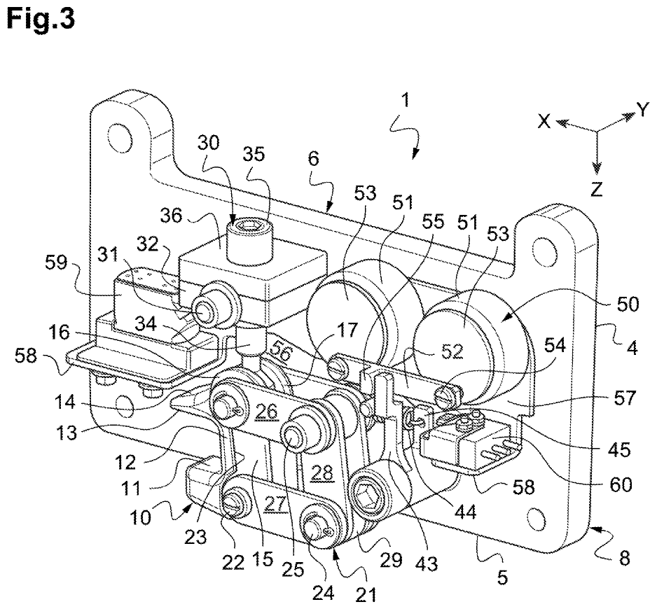

FIG. 3 schematically illustrates in perspective a device according to one aspect of the invention.

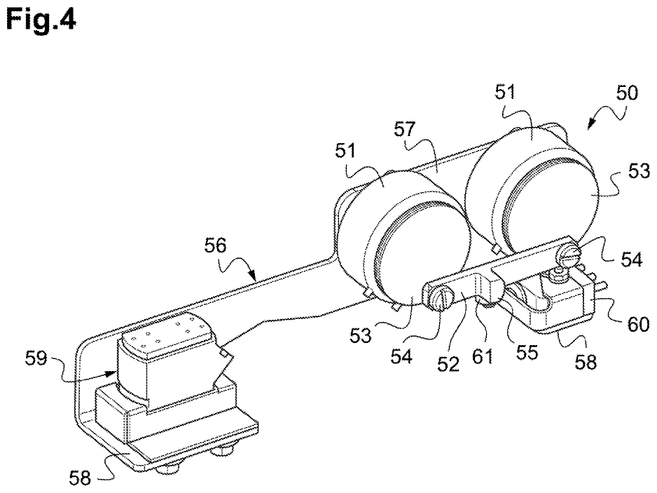

FIG. 4 schematically illustrates in perspective an electrical part of a device according to one aspect of the invention.

FIG. 5 schematically illustrates in perspective a mechanical actuator of a device according to one aspect of the invention.

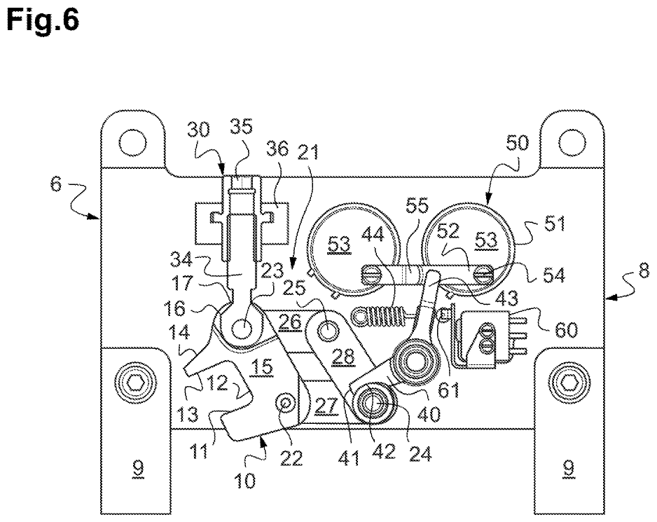

FIG. 6 schematically illustrates in elevation a device in the open state according to one aspect of the invention.

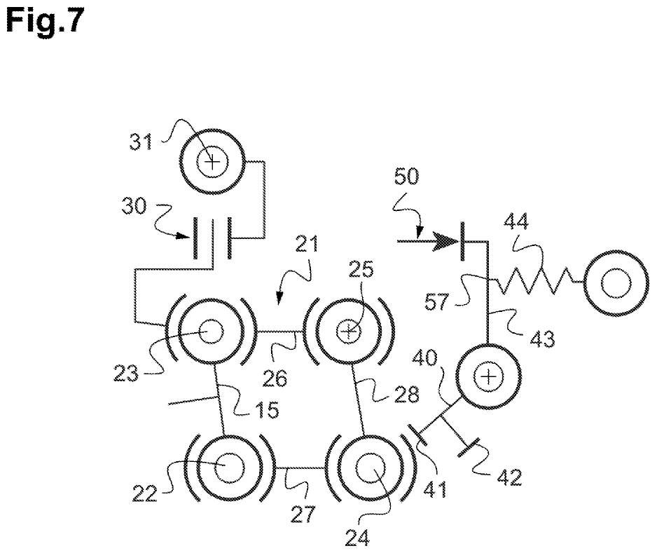

FIG. 7 functionally illustrates a device according to one aspect of the invention.

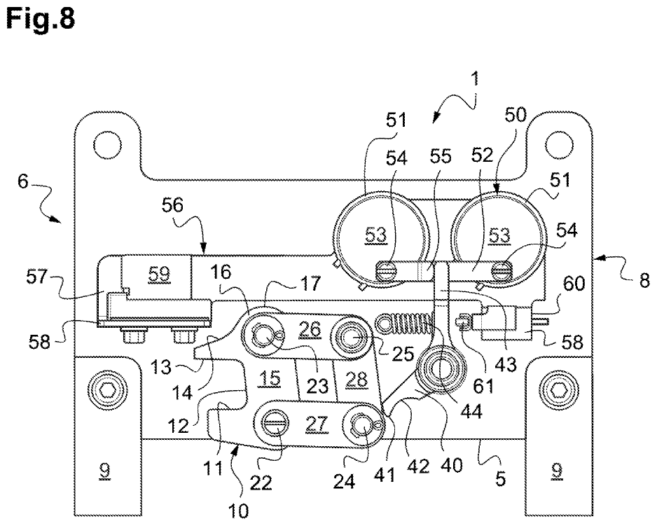

FIG. 8 schematically illustrates in elevation a device in the closed state according to another aspect of the invention.

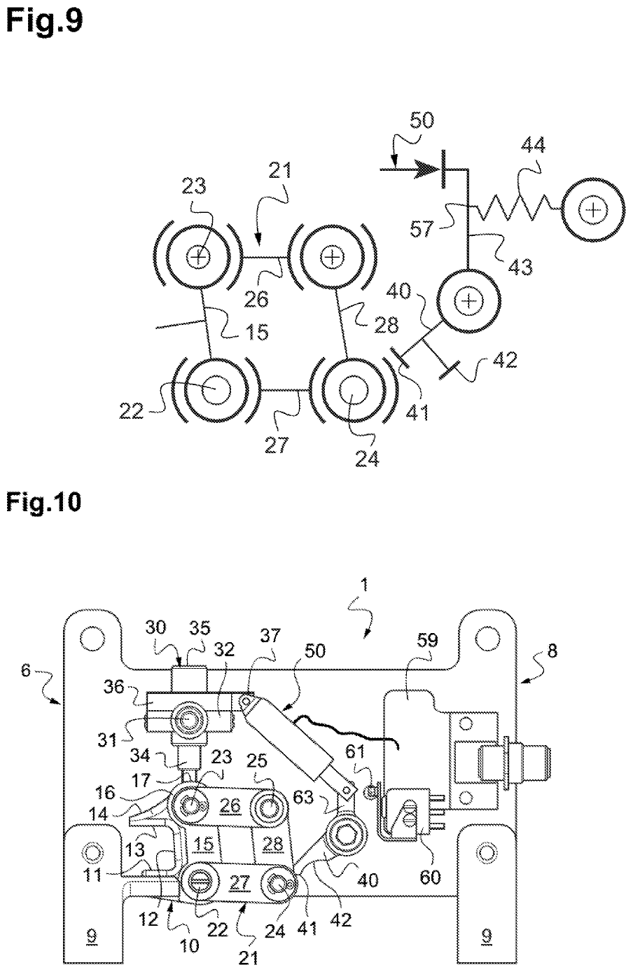

FIG. 9 functionally illustrates a device according to another aspect of the invention.

FIG. 10 functionally illustrates a device according to another aspect of the invention.

The appended drawings may not only be used to complete the invention, but also to contribute to the definition thereof, if applicable.

The figures show a release unit 1 according to one aspect of the invention and the kinematics thereof.

The Applicant realised that the need to attach smaller loads, if applicable greater in number, was not met for aircraft carrying loads outside. Increasing the precision of guided loads makes it possible to reduce the amount of explosive contained. Moreover, loads without explosives and with decimetric precision for reducing damage outside of the target appeared. Observation pods are becoming increasingly lighter. Finally, the development of drones of all sizes creates a specific need to carry light loads.

The release unit 1 is intended to be attached to an aircraft, for example an aeroplane, and to receive an aeronautical vehicle 2 to be released, also called a load. The release unit 1 receives the aeronautical vehicle 2 during loading (on the ground) and separates from said aeronautical vehicle 2 during dropping during flight or unloading on the ground.

The aeronautical vehicle 2 includes a retaining protrusion 20 on one of the walls thereof, in particular a ring. The retaining protrusion 20 may alternatively have a T-shape. The release unit 1 retains the aeronautical vehicle 2 by engaging with the retaining protrusion 20 when loading the release unit 1. Upon dropping, the release unit 1 releases the retaining protrusion 20 of the aeronautical vehicle 2. The aeronautical vehicle 2 moves away from the aircraft by gravity.

The release unit 1 extends along a longitudinal direction X perpendicular to the dropping Z direction, from a front end to a rear end.

In the embodiment described here, the release unit 1 has an elongated appearance along the X direction. Here, the release unit 1 is furthermore generally symmetrical with respect to a plane parallel to the X and Z directions.

The release unit 1 has two opposite side faces 3, 4 in a Y direction orthogonal to the XZ plane. In the figures, the Z direction is oriented downwards. Here, the release unit 1 has a generally planar appearance relative to the Y direction.

The release unit 1 further has a lower face 5, perpendicular to the Z direction. The aeronautical vehicle 2 received by the release unit 1 is facing the lower face. The retaining protrusions 20 are arranged in the vicinity of the ends.

The release unit 1 comprises a frame 6. The frame 6 comprises two half-shells 7, 8 assembled by screwing. The half shells 7, 8 form a housing and a support for the mechanism. Each half-shell forms one of the side faces 3, 4, a part of the lower face 5, a part of an upper face, a part of a front face and a part of a rear face. In other words, each half-shell comprises a bottom corresponding to one of the side faces 3, 4 and a rim surrounding the bottom and corresponding to the part of the lower face 5, the part of the upper face, the part of the front face and the part of the rear face. On the upper face, attachment members may be provided to a support not shown, for example hooks or holes in a projection. The front and back faces are parallel to a YZ plane. The side face 3 and the side face 4 are parallel to an XZ plane.

The release unit 1 comprises two tabs 9 ensuring contact with the load 2. The tabs 9 are arranged at the front and at the rear of the frame 6. The tabs 9 have a concave lower surface for stabilising the load 2 along the Y axis while the release unit exerts a permanent force on the load 2 along the Z axis. Each tab 9 has an upper plate clamped between the half-shells 7, 8 of the frame 9 in the assembled state, see FIG. 1, by means of bolts shown in FIGS. 2 and 3.

The release unit mechanism is installed essentially in the frame 6. The release unit mechanism is supported by the frame 6.

The release unit 1 comprises a hook 10 for retaining and releasing the aeronautical vehicle 2. The hook 10 protrudes from the frame 6 in the release position. The hook 10 may protrude slightly from the frame 6 in the retaining position. The hook 10 has a general C-shape.

The hook 10 comprises a retaining surface 11 substantially parallel to the X axis in the retaining position and inclined in the release position. The retaining surface 11 is part of a lower branch of the C. The hook 10 comprises a positioning surface 12 substantially parallel to the Y axis or, here, inclined towards the retaining surface 11 in the retaining position and inclined in the release position. The positioning surface 12 is part of a bottom of the C. The retaining surface 11 and the positioning surface 12 here form an angle of about 75 to 90°. The hook 10 comprises a pushing surface 13 substantially parallel to the X axis in the retaining position and inclined in the release position. The pushing surface 13 is part of an upper branch of the C. The retaining surface 11 and the pushing surface 13 are parallel and facing each other.

The pushing surface 13 makes it possible for the load 2 to push the hook 10 into the retaining position when docking the load. The positioning surface 12 makes it possible to properly position the load 2 along the X axis when docking the load. The retaining surface 11 exerts a permanent holding force on the load 2 along the Z axis, in the retaining position.

The pushing surface 13 is part of an upper branch of the hook 10. The upper branch has a duckbill shape. The upper branch has an upper surface 14 opposite the pushing surface 13. The upper surface 14 is concave in the vicinity of the free end of the upper branch and convex in the vicinity of a bottom 15 of the hook 10 thus forming an upper bulge 16. The bulge 16 is located in the extension of the bottom.

The positioning surface 12 is part of the bottom 15 of the hook 10. The bottom 15 is thick to provide high mechanical strength. Thus, the dimension of the bottom 15 along the X axis in the retaining position is greater than the dimension thereof along the Y axis. The dimension of the bottom 15 along the X axis in the retaining position is greater than the dimension along the Z axis of a lower branch of the hook 10. The dimension of the bottom 15 along the X axis in the retaining position is greater than the dimension along the Z axis of the upper branch of the hook 10.

The retaining surface 11 is part of the lower branch of the hook 10. The lower branch may have a dimension along the Z axis decreasing as it moves away from the bottom.

The hook 10 is provided with a lower hole and an upper hole for articulation. The upper hole is arranged in the bulge 16, at least partially. The lower hole is arranged in the region common to the lower branch and to the bottom.

The release unit 1 comprises a deformable parallelogram mechanism 21. The deformable parallelogram mechanism 21 is arranged between the half-shells 7, 8, at least mostly. The deformable parallelogram mechanism 21 may protrude under the lower face 5.

In the embodiment of FIGS. 1 to 7, the deformable parallelogram mechanism 21 comprises four articulation axis and four arms. One of the arms is formed by the hook 10. The other arms here include two parallel bars. The first axis 22, the second axis 23 and the third axis 24 are movable relative to the frame 6. The fourth axis 25 is fixed relative to the frame 6. The first and second axis 22, 23 are mounted secured to the hook 10. The first and second axis 22, 23 pass through the lower and upper holes of the hook 10 respectively. The third axis 24 is lower while the fourth axis 25 is upper. The third axis 24 supports a bearing 29. The bearing 29 is preferably a roller bearing. The fourth axis 25 is mounted secured to the frame 6. The fourth axis 25 may be fixed in the recesses of each half-shell. The fourth axis 25 is fixed.

One of the arms is upper, while another is lower and another is rear and opposite the hook 10. The upper arm 26 and the lower arm 27 are parallel. The upper and lower arms 26, 27 are oriented along the X axis to within +−5°. The upper arm 26 is articulated at the second and fourth axis. The lower arm 27 is articulated at the first and third axis. The rear arm 28 is articulated at the third and fourth axis.

During an opening movement of the hook 10, the upper arm 26 is stationary and the lower arm 27 is movable. The movement of the lower arm 27 is initially backward, then increasingly upwards. The retaining surface 11 of the hook 10 pivots about the second axis. In other words, the retaining surface 11 moves backward while inclining, thereby releasing the load. The closing of the hook 10 is carried out by reverse movement. In the release position, the deformable parallelogram mechanism 21 has a folded shape, the upper arm 26 and the lower arm 27 being close to one another, or even in contact. In the retaining position, the deformable parallelogram mechanism 21 has a deployed shape close to a rectangle or rectangular. The upper arm 26 and the lower arm 27 are spaced apart from one another.

The release unit 1 comprises a mechanical actuator 30 acting on the hook 10 for adjusting the height-locked position along the Z axis, see FIG. 5. The mechanical actuator 30 acts directly on the hook 10. Indeed, different loads likely to be carried may have different geometries, in particular different rings and different bodies. The mechanical actuator 30 is supported by the frame 6. The mechanical actuator 30 is pivotably mounted in the frame 6 about a transverse axis oriented along the Y axis. The mechanical actuator 30 comprises two trunnions 31, each supported by one of the half-shells 7, 8, and a plate 32 substantially in the same plane as the trunnions 31. The plate 32 is, here, one-piece with the trunnions 31.

The mechanical actuator 30 comprises a ring 33 adjustable in height by movement along the Z axis. The ring 33 is arranged under the plate. The ring 33 is engaged with the second axis of the deformable parallelogram mechanism 21. Here, the ring 33 passes between two lugs 17 of the hook 10, see FIG. 3. The lugs 17 may be arranged in the bulge 16. The upper hole of the hook 10 passes through the lugs 17. The ring 33 is one-piece with a rod 34 directed towards the plate 32.

The mechanical actuator 30 comprises a screw 35 and a cover 36. The screw 35 rests on the plate 32. The screw 35 is free to rotate relative to the plate 32. The screw 35 is engaged by threading with the rod 34 of the ring 33 forming a nut. The screw 35 and the nut are pivotably mounted relative to the frame 6. The screw 35 is pivotable relative to the hook 10 thus making it possible to adjust in position.

The screw 35 has a drive recess, here with a hexagon socket, accessible through a hole in the cover. The cover 36 holds the screw 35 relative to the plate 32. The cover 36 is detachably fixed to the plate 32, here by means of screws. Rotating the screw 35 in one direction causes the ring 33 and the plate 32 to come closer together, i.e. raises the ring.

The second axis of the deformable parallelogram mechanism 21 and the hook 10 move upwards. The height of the hook 10 is adjustable. In general, the adjustment of the height of the hook 10 is carried out in the retaining position with an attached load. In the case of a new type of load, the hook 10 can be adjusted to the low position before the installation of the load by rotating the screw 35 in the reverse direction, and then raised by rotating the screw 35 in the first direction. The adjustment of the preloading may be carried out by measuring the torque applied to the screw 35. A torque wrench may be used.

The mechanical actuator 30 is pivotably mounted about an axis of the frame 6. The mechanical actuator 30 is connected to one of said two axis secured to the hook 10, here the second axis 23. The second axis 23 ensures two pivot links.

Alternatively, the mechanical actuator 30 is connected to the first axis 22. Alternatively, the mechanical actuator 30 is connected to another axis parallel to the first axis 22.

The bars of the upper arm 26 are mounted on either side of the lugs 17 of the hook 10. The bars of the lower arm 27 are mounted on either side of the hook 10. The bars of the rear arm are mounted inside the bars of the upper arm 26 and the bars of the lower arm 27. The bars of the rear arm are separated by a bearing 29 on the third axis 24 and by a spacer on the fourth axis 25. The bearing 29 may comprise a roller, for example made of stainless steel.

The release unit 1 comprises a first cam 40 mounted so as to rotate about an axis in the frame 6. The axis of the first cam 40 is parallel to the axis of the deformable parallelogram mechanism 21. The axis of the first cam 40 is arranged outside of the deformable parallelogram mechanism 21. The axis of the first cam 40 is arranged on the side of the deformable parallelogram mechanism 21 opposite the hook 10. The first cam 40 is articulated with the frame 6. The first cam 40 has a position for locking the deformable parallelogram mechanism 21 by contact with the bearing 29 mounted on the third axis. The first cam 40 has a locking surface 41 arranged in a plane normal to an axis intersecting the third axis and the axis of the cam and perpendicular to the third axis and to the axis of the cam.

The first cam 40 has a remote position for unlocking said bearing 29. In the unlocking position, the first cam 40 protrudes between the bars of the rear arm 28.

The first cam 40 has on a lateral edge a rounded concave area 42. The concave area 42 may be in contact with the bearing 29 in the unlocking position to ensure a stable unlocking position. The stable unlocking position is deactivated when a pushing is applied to the hook 10 upwards by a load to be installed. The concave area 42 may have a bottom corresponding to the contact position with the bearing 29 in the unlocking position and a trailing edge having an angle of about XX to XX° relative to the axis intersecting the third axis and the axis of the cam and perpendicular to the third axis and to the axis of the cam in the unlocking position. The concave area 42 may have a radius of curvature greater than the outer radius of the bearing 29.

The first cam 40 forms a control of the deformable parallelogram mechanism 21.

The first cam 40 has a drive recess, here with 6 hexagon sockets, accessible through a hole in the cover. The operating key 70 can be inserted therein. Rotating the first cam 40 clockwise causes it to unlock.

The release unit 1 comprises a second cam 43 coupled to the first cam 40. Here, the second cam 43 is one-piece with the first cam 40. The second cam 43 is directed upwards. The second cam 43 has an active side surface. The active surface is unique. The active surface is oriented according to a plane passing through the axis of rotation of the first and second cams. The second cam 43 forms an angle of about 120° with the first cam 40. The first and second cams 40, 43 form a transmission assembly.

The release unit 1 comprises an elastic member 44 for preloading the first cam 40 in the locking position. The elastic member 44 is, here, a helical spring. The release unit 1 advantageously comprises a single spring. The elastic member 44 is, here, in tension. The elastic member 44 is fixed at one end to a pin secured to the frame 6. The elastic member 44 is fixed to another end to a finger 45 secured to the first and second cams 40, 43. The finger 45 may be one-piece with the first and second cams 40, 43. The elastic member 44 exerts a force towards the locking position and tending to the stability of the unlocking position.

In another embodiment, the elastic member 44 is fixed at one end to the spacer of the fourth axis.

In another embodiment, the elastic member 44 is fixed to another end to the first or second cam.

The release unit 1 comprises an electric actuator 50 for releasing the aeronautical vehicle 2. The electric actuator 50 actuates the second cam 43 in the unlocking direction. The electric actuator 50 exerts a force on the active surface of the second cam 43. The electric actuator 50 may make it possible for or actuate the second cam 43 to return in the unlocking direction.

The electric actuator 50 comprises two rotary motors 51 and a connecting rod 52 for coupling the two rotary motors 51. The rotary motors 51 are identical. The rotary motors 51 are mounted in the frame 6. The rotary motors 51 are supported by the frame 6. Each rotary motor 51 is provided with an eccentric 53. The connecting rod 52 is articulated on the eccentric of each rotary motor 51. The connecting rod 52 is held on the eccentric 53 by a screw 54. Here, the eccentrics 53 are oriented at the same angle. Each eccentric 53 comprises a disc secured to a motor output shaft and a pin distant from the axis of the rotary motor 51 and receiving the screw 54.

The connecting rod 52 includes a protruding pin 55 substantially arranged in the middle of the connecting rod. The pin 55 is located on the side of the connecting rod 52 opposite the rotary motors 51. The pin 55 has a shape adapted to the shape of the active surface of the second cam 43. The pin 55 is in contact with the active surface of the second cam 43.

The two rotary motors 51 having an idle position and an active position. In the idle position, the eccentrics 53 are arranged between 6 and 9 o'clock in side view, here at about 6 o'clock. In the active position, the eccentrics 53 are arranged between 3 and 6 o'clock in side view, here at about 5 o'clock. Thus, the connecting rod 52 is moved backwards by switching from the idle position to the active position. The pin 55 of the connecting rod 52 pushes the second cam 43 in rotation in the clockwise direction against the elastic member 44. The locking surface 41 of the first cam 40 slides on the bearing 29 of the deformable parallelogram mechanism 21 and loses contact with said bearing 29. The first cam 40 is then located between the third and fourth axis. Under the effect of gravity on the load carried by the release unit 1, the hook 10 opens by pivoting counterclockwise about the second axis, the lower arm 27 moves backwards. The load separates from release unit 1.

The electric actuator 50 is subsequently deactivated after a few seconds. Under the effect of the elastic member 44, the first and second cams 40, 43 rotate counterclockwise. The concave area 42 of the first cam 40 bears on the bearing 29 of the deformable parallelogram mechanism 21. Thus, the first cam 40 retains the deformable parallelogram mechanism 21 in the unlocked position, see FIG. 6.

When a new load is brought into position for placement under the release unit 1, the ring of the load enters the hook 10 and pushes the pushing surface 13. The hook 10 pivots when closing. The lower arm moves forward against the retaining force exerted by the concave zone 42 of the first cam 40 on the bearing. The bearing 29 moves away from the first cam 40. The first cam 40 with the second cam 43 pivots counterclockwise under the action of the elastic member 44. The second cam 43 returns the connecting rod 52 to the initial position thereof, see FIG. 3.

The rotary motors 51 rest on the frame 6 via a sub-frame 56, see FIG. 4. The sub-frame 56 comprises a bent sheet metal plate with a body 57 according to the XZ plane and two tabs 58 according to the XY plane. One of the tabs 58 is arranged at the front of the frame 6 beyond the mechanical actuator 30. The front tab supports a control electronics 59 of the rotary motors 51 connected to the rotary motors 51.

The other tab 58 is arranged at the rear of the frame 6 beyond the cams 40, 43, under one of the rotary motors 51. The rear tab supports a connection plug 60 connected to the control electronics 59. Thus, the electrical part of the release unit 1 may be easily disassembled. A switch 61 is connected to the control electronics 59. The switch 61 is mounted next to the connection socket 60. The switch 61 is configured to be activated by pressing the first cam 40, the second cam 43 or the finger 45. Here, the second cam 43 activates the switch 61 during the unlocking.

In FIG. 4, the electrical wires have been omitted for the sake of clarity of the drawing.

In FIG. 1, a key 70 for manoeuvring the cams 40, 43 is further shown. The key 70 when actuated by an operator moves the first cam 40 from the locking position to the unlocking position and vice versa.

In other words, the hook 10 ensures three pivot links, a retaining contact and a locking engagement contact.

The release unit 1 is provided with six pivot axis parallel to one another. The six pivot axis form an irregular hexagon. Of the six pivot axis, three are fixed relative to the frame and three are movable relative to the frame. The engagement movement by the aeronautical vehicle, the adjustment movement of the preloading and the release movement of the aeronautical vehicle are thus ensured by a simple mechanism comprising a reduced number of parts. A part may ensure movement transmission from the actuator, automatic locking, automatic unlocking, manual unlocking, stability of the locked position and stability of the unlocked position.

In other words, and as illustrated in FIG. 7, the release unit 1 performs 23 functions or links in 10 parts. The 10 parts comprise: the four arms of the deformable parallelogram 21 of which the arm formed by the hook 10, the mechanical actuator 30, the two one-piece cams 40, 41, the bearing 29 cooperating with the first cam, the elastic member 44, the connecting rod 52, and at least one electric motor 51. For safety by redundancy, an additional electric motor 51 is provided according to the mode of FIGS. 1 to 6. The release unit 1 is provided with four pivot links relative to the frame 6 in addition to the axis of the electric motor(s) 51 and three movable pivot links. The pivot links relative to the frame 6 comprise the fourth axis 25, the axis of the first cam 40 and of the second cam 43, the pin secured to the frame 6 and supporting an end of the elastic member 44, and the trunnions 31 making it possible for the mechanical actuator 30 to pivot in the Y direction. The movable pivot links comprise the first axis 22, the second axis 23 and the third axis 24.

The mechanical functions of the release unit 1 comprise rotating the cams of the first cam 40 and of the second cam 43, the abutment of the first cam 40 relative to the bearing 29, applying the first cam 40 on the bearing 29 in the unlocked position, applying the connecting rod on the second cam 43, a pivot between the elastic member 44 and the finger 45, driving the first cam 40 and the second cam 43 by the drive recess, applying the second cam 43 on the switch 61, pivoting the elastic member 44 relative to the pin secured to the frame 6, rotating the bearing 29, rotating the upper arm 26 about the second axis 23, rotating the upper arm 26 about the fourth axis 25, rotating the lower arm 27 about the first axis 22, rotating the lower arm 27 about the third axis 24, rotating the rear arm 28 about the third axis 24, rotating the rear arm 28 about the fourth axis 25, rotating the hook 10 about the first axis 22, rotating the hook 10 about the second axis 23, the holding force exerted on the load by the retaining surface 11 of the hook 10, the locking force exerted by the load on the pushing surface 13 of the hook 10, rotating the mechanical actuator 30 about the second axis 23, rotating the mechanical actuator 30 about the trunnions 31, changing the length of the mechanical actuator 30 screw-nut i.e. a sliding pivot, and driving the mechanical actuator 30 by the drive recess.

Furthermore, one or more anti-rotational vibration brakes may be provided.

In one embodiment, at least one of the 11 parts is replaced by two parts. Thus, at least one arm of the deformable parallelogram may be made in two articulated portions to add a function or improve an existing function in the embodiment of FIGS. 1 to 7.

In one embodiment, the connecting rod 52 is made in two parts articulated with each other and articulated with the second cam.

In one embodiment, the two cams 40, 41 are made in two parts.

In the embodiment of FIGS. 8 and 9, the same references refer to the same parts. The structure is similar except for the mechanical actuator which is absent. The second axis 23 is secured to the frame. The upper arm 26 may be omitted. In other words, the frame 6 forms the upper side of the deformable parallelogram. The deformable parallelogram mechanism 21 has the second axis 23 secured to the frame 6 and to the hook 10 and the fourth axis 25 secured to the frame 6.

The height of the hook is determined by construction. The height of the hook in locked position is constant. Such an arrangement is very well suited to light loads, in particular less than 10 kg, for which the retaining projections 20 may easily be elastic enough to accommodate manufacturing tolerances. The release unit has a low weight.

The release unit 1 performs 19 functions or links in 9 parts. The 9 parts comprise: the three arms of the deformable parallelogram 21 of which the arm formed by the hook 10, the two one-piece cams 40, 41, the bearing 29 cooperating with the first cam, the elastic member 44, the connecting rod 52, and at least one electric motor 51. For safety by redundancy, an additional electric motor 51 is provided according to the mode of FIGS. 1 to 6. The release unit 1 is provided with four pivot links with respect to the frame 6 in addition to the axis of the electric motor(s) 51 and two movable pivot links. The pivot connections relative to the frame 6 comprise the second axis 23, the fourth axis 25, the axis of the first cam 40 and of the second cam 43, and the pin secured to the frame 6 and supporting an end of the elastic member 44. The movable pivot links comprise the first axis 22 and the third axis 24.

The mechanical functions of the release unit 1 comprise rotating the cams of the first cam 40 and of the second cam 43, the abutment of the first cam 40 relative to the bearing 29, applying the first cam 40 on the bearing 29 in the unlocked position, applying the connecting rod on the second cam 43, a pivot between the elastic member 44 and the finger 45, driving the first cam 40 and the second cam 43 by the drive recess, applying the second cam 43 on the switch 61, pivoting the elastic member 44 relative to the pin secured to the frame 6, rotating the bearing 29, rotating the lower arm 27 about the first axis 22, rotating the lower arm 27 about the third axis 24, rotating the rear arm 28 about the third axis 24, rotating the rear arm 28 about the fourth axis 25, rotating the hook 10 about the first axis 22, rotating the hook 10 about the second axis 23, the holding force exerted on the load by the retaining surface 11 of the hook 10, and the locking force exerted by the load on the pushing surface 13 of the hook 10.

In the embodiment of FIG. 10, the same references refer to the same parts. The structure is similar to that of FIGS. 1-7 except with respect to the electric actuator 50. The elastic member is absent.

The electric actuator 50 is here linear and ensures a preloading function such as the elastic member of the embodiment of FIGS. 1-7. The second cam is replaced by an arm 63 secured to the first cam 40. Said arm 63 comprises an end connecting to the first cam 40 and an end articulated with the electric actuator 50. Thus, said arm 63 is articulated with the electric actuator 50 and pivoting about the axis of the first cam 40. The electric actuator 50, opposite said arm 63, is articulated at a fixed point. The fixed point may be a member secured to the frame. The fixed point may be a finger of the frame. The fixed point, here, is supported by a lateral projection 37 arranged on an edge of the cover 36 of the mechanical actuator 30. The electric actuator 50 is powered by a wire connected to the control electronics 59.

In other words, the release unit 1 performs 21 functions or links in 8 parts. The 8 parts comprise: the arms 26, 27, 28 and the hook 10 forming an arm of the deformable parallelogram 21, the mechanical actuator 30, the cam 40, the bearing 29 cooperating with the first cam, and the electric actuator 50. The release unit 1 is provided with four pivot links relative to the frame 6 in addition to the axis of the electric motor(s) 51 and four movable pivot links. The pivot links relative to the frame 6 comprise the fourth axis 25, the axis of the first cam 40, the articulation secured to the frame 6 and supporting an end of the electric actuator 50, and the trunnions 31 making it possible for the mechanical actuator 30 to pivot in the Y direction. The movable pivot links comprise the first axis 22, the second axis 23, the third axis 24 and the arm 63—electric actuator 50 articulation.

The mechanical functions of the release unit 1 comprise rotating the cam 40 and the arm 63, the abutment of the cam 40 relative to the bearing 29, applying the cam 40 on the bearing 29 in the unlocked position, driving the cam 40 by the drive recess, pivoting the electric actuator 50 relative to the arm 63, pivoting the electric actuator 50 relative to the member secured to the frame 6, rotating the bearing 29, rotating the upper arm 26 about the second axis 23, rotating the upper arm 26 about the fourth axis 25, rotating the lower arm 27 about the first axis 22, rotating the lower arm 27 about the third axis 24, rotating the rear arm 28 about the third axis 24, rotating the rear arm 28 about the fourth axis 25, rotating the hook 10 about the first axis 22, rotating the hook 10 about the second axis 23, the holding force exerted on the load by the retaining surface 11 of the hook 10, the locking force exerted by the load on the pushing surface 13 of the hook 10, rotating the mechanical actuator 30 about the second axis 23, rotating the mechanical actuator 30 about the trunnions 31, changing the length of the mechanical actuator 30 screw-nut i.e. a sliding pivot, and driving the mechanical actuator 30 by the drive recess.

The embodiments of FIGS. 8-9 on the one hand and FIG. 10 on the other hand may be combined. In this case, the second axis 23 is fixed to the frame 6. The electric actuator 50 is articulated with a pin secured to the frame 6, for example moulded, machined or attached. The member 44 for preloading the first cam 40 in the locking position is replaced by the electric linear actuator 50. In other words, the preloading in the locking position and the unlocking control are ensured by the same member. Said member comprises the electric linear actuator mounted between an arm secured to the first cam 40 and a stationary pivot. The release unit 1 performs 1 function or links in 6 parts.

1. An aeronautical conveying and dropping device for an aeronautical vehicle to be released, comprising:
a frame,
a hook capable of holding the aeronautical vehicle to be released,
a deformable parallelogram mechanism having an axis secured to the frame, two axis secured to the hook and a free axis, arranged in the frame
a first cam mounted so as to rotate about an axis fixed in the frame and having a position for locking the deformable parallelogram mechanism contact with a bearing mounted on the free axis of the deformable parallelogram mechanism, and an unlocking position, and
a member for preloading the first cam in the locking position.

2. The device according to claim 1, comprising a second cam coupled to the first cam and an electric actuator (50) for releasing the aeronautical vehicle, actuating the second cam in the unlocking direction, the electric actuator comprising at least one rotary motor having an idle position and an active position and a connecting rod.

3. The device according to claim 2, wherein the connecting rod couples two rotary motors, the two rotary motors having an idle position and an active position, the connecting rod pushing the second cam.

4. The device according to claim 2, wherein the connecting rod comprises a pin in contact with the second cam, the pin being arranged between the rotary motors.

5. The device according to claim 2 4, wherein the rotary motor has an axis parallel to the axis of rotation of the first and second cams.

6. The device according to claim 2, wherein the first and second cams are one-piece.

7. The device according to claim 1 comprising a preloading member acting on the first and second cams by exerting a force towards the locking position.

8. The device according to claim 1, wherein the first cam has an active surface for blocking the parallelogram mechanism, said surface being rounded convex.

9. The device according to claim 1, wherein the first cam has a concave active surface in contact with the bearing in the unlocked position to provide a stable unlocking position.

10. The device according to claim 1, comprising a mechanical actuator acting on the hook for adjusting the locked position, the mechanical actuator being mounted pivoting about an axis of the frame and connected to one of said two axis secured to the hook.

11. The device according to claim 10, wherein the mechanical actuator acts directly on the hook, the mechanical actuator comprising a screw engaged in a nut, the nut being pivotably mounted relative to the frame and the screw being pivotably mounted relative to the hook.

12. The device according to claim 1, wherein the deformable parallelogram mechanism has two axis secured to the frame one of which is secured to the hook.

13. The device according to claim 1, wherein the preloading member comprises a spring connected to a finger secured to the first cam.

14. The device according to claim 1, wherein the preloading member comprises a magnet forming part of the rotary motor(s).

15. The device according to claim 1, comprising a controlled linear actuator mounted between an arm secured to the first cam and a member secured to the frame.
